(19) United States
(12) Patent Application Publication
(10) Pub. No.: US 2013/0019152 A1
(43) Pub. Date: Jan. 17, 2013

(54) Method and Apparatus for Tracking Exit Destinations of Web Page

(71) Applicant: William R. RAU, Snohomish, WA (US)

(72) Inventor: William R. RAU, Snohomish, WA (US)

(21) Appl. No.: 13/183,378

(22) Filed: Jul. 14, 2011

(51) Int. Cl. G06F 17/00

(52) U.S. Cl. 715/208

(57) ABSTRACT

Web analytics can be collected without inter-domain cooperation and without altering source documents by transmitting an executable program with a tracked document, the program to examine and modify hyperlinks in a Document Object Model created based on the tracked document, so that modified hyperlinks, when activated, report information of interest before sending the web browser to the hyperlink target destination.

### CLAIM OF PRIORITY

This is an original U.S. patent application.

### FIELD

The invention relates to data collection and analysis. More specifically, the invention relates to methods for tracking interactions between users and data servers over the Internet.

### BACKGROUND

The Internet is a global system of interconnected computer networks that supports communication between endpoints and among participating entities. Many different protocols are used to send and receive a wide range of different data types, from simple command and control signals to text, audio, images and video. One common protocol is the Hypertext Transfer Protocol (“HTTP”), specified in a series of Request for Comments (“RFC”) documents, the most recent of which is RFC2616, published June 1999 by The Internet Society. HTTP is the basic workhorse protocol underlying the World Wide Web.

The World Wide Web is system of interlinked hypertext documents that may be accessed via the Internet, often using a computer program called a “browser.” The hypertext documents are stored at (or generated by) computers (“servers”) located at various places in the system of interconnected computers, and are delivered to users at other computers (“clients”) in response to requests from those clients.

There is no centralized registry or monitoring service that indexes all the materials available via the Internet or tracks what clients request or servers deliver).¹ Users are relatively unconstrained in the materials they request and the order they request them; while content providers have only modest control over the materials they deliver (providers can refuse to send a requested item, or send something else instead, but cannot generally compel the user to browse from one document to the next). Further, providers have only a limited ability to track user activity: they can usually determine which documents and document sequences a particular user retrieves from their own servers, but not what the user viewed before visiting their servers, or where the user went after his visit. ¹Internet “Search Engines” such as the service operated by Google, Inc. of Mountain View, Calif., do attempt to index resources available via the Internet, and these are an important source of information. However, while many content providers seek to be listed in search engines' databases, such listing is neither compulsory nor assured.

This tracking or history data is of great interest to many entities offering products, services and information through the Internet. An entire industry of web analytics tools have emerged to give web content providers a detailed view of how their content is consumed. These tools can tell you, for instance, how many users viewed a given page on a certain clay, where in the world those users are, and what if any other web site referred them to the content producer's site. Web content providers make great use of these tools in order to better understand their user base, and thus better achieve their goals (e.g., more viewers, more profit, etc.) through better understanding of their audience.

A variety of techniques have been developed to improve tracking ability and accuracy, but many of these require cooperation among entities. This exposes a website operator to financial, legal and technical liabilities² clue to the cooperation, and the liabilities may outweigh the value of the information, or at least partially offset its value. ²For example, the cooperating entity can also collect information about the website's visitors, and may charge a fee for its cooperation.

An independent website operator, acting alone, may have more limited information available to it, or may have to resort to technical measures to collect information that adversely impact its business in other ways. Alternate methods of collecting information about website visitors may be of significant value in this field.

### SUMMARY

A website using an embodiment of the invention sends a client-side program to a browser, along with other materials requested by the browser. The client-side program dynamically alters the browser's handling of some hyperlinks in a document, without changing the textual representation of the hyperlinks, so that the browser reports activation of an altered hyperlink to the website, even when activation of the hyperlink causes the browser to retrieve resources from a different website.

### BRIEF DESCRIPTION OF DRAWINGS

Embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

FIG. 1 is a flow chart outlining operations of an embodiment of the invention.

FIG. 2 is a flow chart showing generally how web browsing proceeds.

FIG. 3 is a flow chart showing operations of a service-bureau embodiment of the invention.

FIG. 4 is a flow chart detailing a portion of an operation of a preferred embodiment of the invention.

### DETAILED DESCRIPTION

Embodiments of the invention track some website-visitor departures by transmitting a client-side executable program that dynamically modifies a Document Object Model (“DOM”) structure created by the visitor's browser in the course of displaying a requested document. The modified DOM causes the browser to report activation of outbound links. Since the DOM is modified dynamically, the document content (including any exit destinations) can be indexed properly by a search engine. The operator of a website that employs an embodiment of the invention can track site departures without the cooperation of the external (destination) site's administrators.

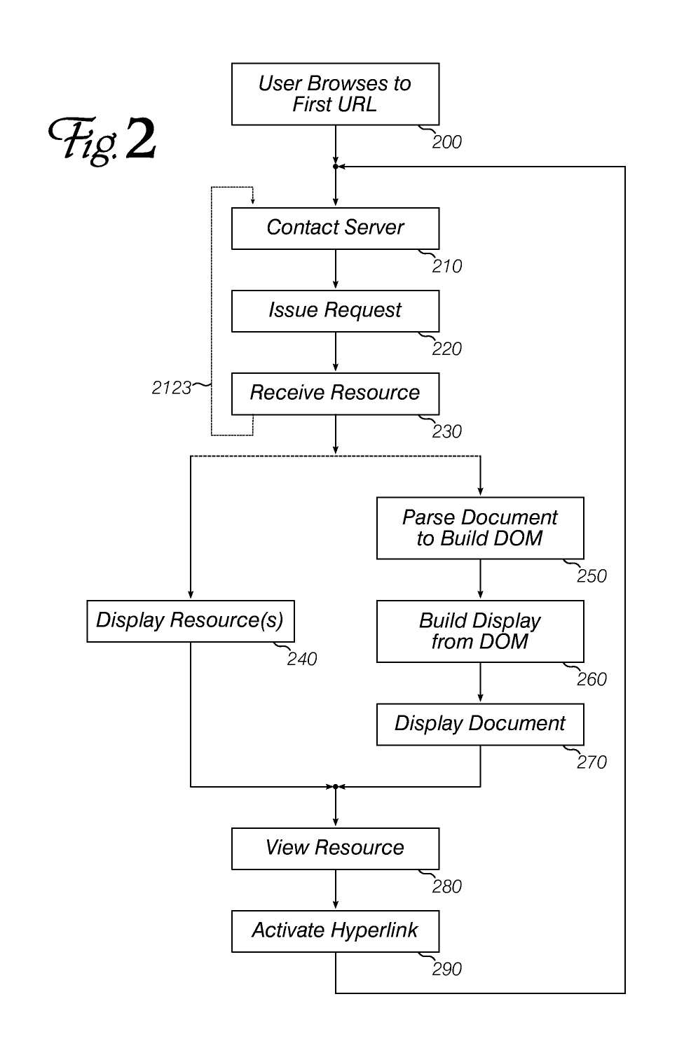

FIG. 2 shows an overview of the web-browsing process. Although browsing is simple and intuitive from the perspective of a user operating web browser software, it requires cooperation among dozens of computers and communications systems. The overview shown is intended to draw attention to portions of the process that are most directly impacted by an embodiment of the invention, while glossing over reciprocal activities that are done by other participating computers. Web developers and network administrators of ordinary skill will be able to locate the machine or machines responsible for portions of the activities and determine how best to divide the activities to implement an embodiment among the computers available to perform the necessary functions.

At 200, the user directs his browser to retrieve a first web resource. This initial request may come from activation of a hyperlink in another program (e.g., an email viewer or a computer game), or the user may enter a Uniform Resource Locator (“URL”) manually. The browser contacts a web server via the Internet (210), issues a request for the resource (220), and receives data comprising the resource (230). Steps 210, 220 and 230 may be repeated several times (2123) to obtain related resources that are necessary to prepare or display the resource that the user wishes to view. Some types of data (e.g., images, audio) can be displayed or played for the user directly (240), while others (principally Hypertext Markup Language [“HTML”] documents) are parsed to create an in-memory Document Object Model (“DOM”) (250) which is further processed to produce a formatted representation for display (260) and then presented to the user (270).

A DOM may direct the browser to retrieve additional resources (e.g., images, fonts, formatting information or executable code) for use in preparing the display, so the browser may automatically issue additional requests to the web server and process the additional resources appropriately. In other words, steps 250, 260 and 270 may cause additional excursions through steps 210, 220 and 230.

Once the requested resource has been retrieved, prepared and presented, the user can review it (280). A word, phrase or image may be configured as a hyperlink to further information, and if the user activates the link (by using a browser-supported control action) (290), the browser repeats the retrieving-and-displaying sequence to show the linked-to information (or “target” of the hyperlink). Note that some hyperlinks refer the browser to a different resource available from the same web server, while others refer to a resource available from a different web server. The latter type of link will be called an “exit” link, since the browser normally ceases its interactions with the first web server, and starts a new conversation with a second web server. (Servers are often grouped together by a “domain” within which they operate. Domains are apparent to users as part of the URL. For example, the two URLs “http://www.example.com/doc1.html” and “http://www.example.com/doc2.html” refer to two resources, doc1.html and doc2.html, which are available from servers in the same www.example.com domain—in fact, possibly from a single server in that domain. On the other hand, the URL “http://www.other-domain.com/whitepaper.pdf” refers to a third resource which is available from a server at a different domain. It is appreciated that, at the server end, a single server may respond to requests for resources from different domains, or requests for resources from the same domain may be redirected to different servers. However, generally speaking, an embodiment of the invention is most beneficial in tracking a client's destination as it browses from server(s) in one domain, to an unrelated server in a different domain.)

Web analytics tools do not in general show exit destinations today, because the information is difficult to collect. One prior-art method of measuring exit destination involves creating an “intermediate” URL that is owned by the content provider. The purpose of this URL is to capture the exit destination and then forward the user to that destination. For example, if “mysite.com” wanted to create a link to send users to “scoutanalytics.com”, mysite.com would actually create a link of the form:

http://mysite.com/exit-track?destination=scoutanalytics.com This link really goes to mysite.com, not (directly) to scoutanalytics.com. The server for mysite.com would track the destination, and then redirect the user to the intended destination.

This prior-art method has considerable drawbacks. First, the site owner must create and manage the tracking mechanism. Second, users can determine that the URLs do not point to the ultimate destination directly, which may create user confusion. Third, search engines will not correctly interpret these links as pointing to the remote sites.

Embodiments of the invention provide a superior solution to the problem of tracking exit destinations, at least because:
The outgoing (exit) URLs on a page do not need to be modified to be tracked
The target site those URLs point to does not have to be modified
The origin-site operators can obtain the desired information without cooperation from the target site
No system is required to process intermediate URLs
The user is not shown the intermediate URLs
For sites already in place, links that directly retrieve binary objects to be opened in the browser (e.g., Adobe® PDF files and Microsoft Word and Excel files) can be tracked without modifying the site structure or changing the URLs. (Previous methods have required an intermediate page to handle these exits.)

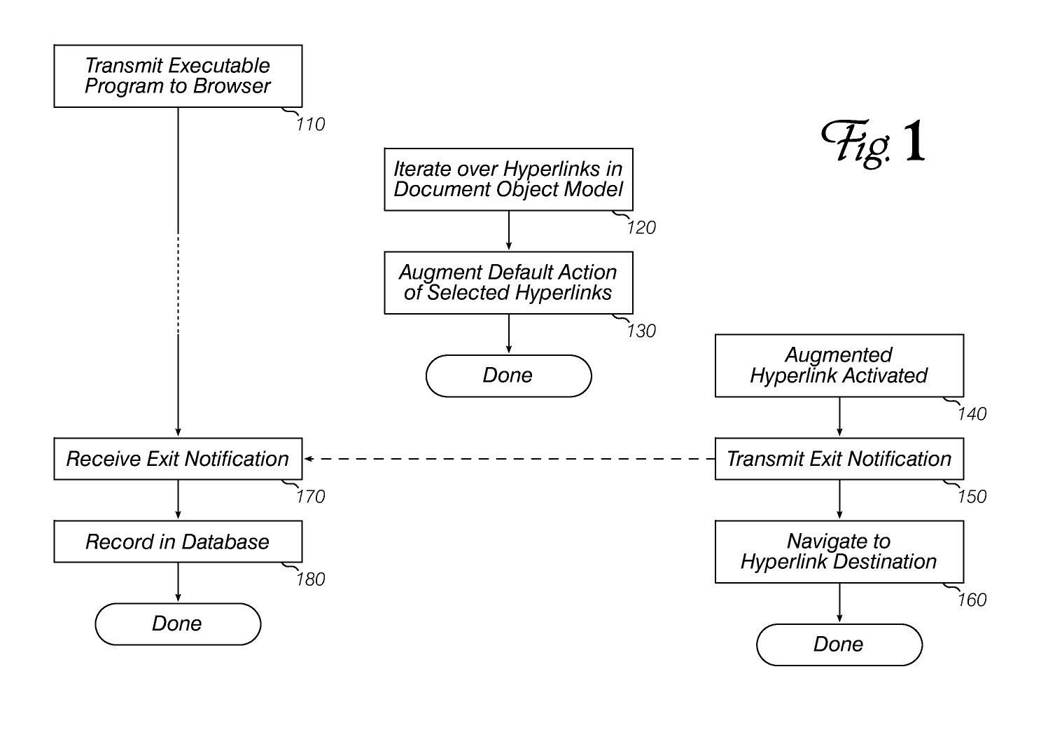

An embodiment of the invention adds a small amount of executable code to the materials transmitted to the web browser in response to a request, to cause the web browser to perform additional operations (apart from the normal operations outlined in FIG. 2). As explained above, many computers participate in delivering a seamless browsing experience to a user, and so an embodiment of the invention may affect the operations of several different devices. FIG. 1 provides an outline of things that occur when an embodiment is in use.

At 110, an executable program is transmitted to a web browser. This program may be inserted into another resource being transmitted, or may be referred to from such a resource, so that the browser makes an additional request to obtain the program. The program may be executable instructions in a scripting language such as JavaScript™, byte codes compiled for an interpreter such as Java™, machine instructions for a processor implementing an instruction set such as Intel® 64, IA-32 or ARM®, or a combination of such instructions. In one preferred embodiment, the instructions are in JavaScript, and utilize the jQuery library of functions.

The executable program causes the web browser to perform additional activities while generating and processing a Document Object Model in preparation for display: first, the browser iterates over hyperlink objects in the DOM (120), and for at least some hyperlinks, a modification is made to cause the browser to perform additional actions if the hyperlink is activated (130). This modification is made dynamically, to an ephemeral, often in-memory DOM, rather than to the original resource (e.g., the HTML document) from which the DOM was created. Thus, neither the original resource (at the server) nor the resource (at the machine that retrieved it) is modified. This is an important difference: some prior-art methods of performing exit tracking require modification of hyperlinks in the source document from which the DOM is prepared. Such modified hyperlinks are often indexed differently (and unfavorably) by Internet search engines.

Finally, when one of the augmented or modified hyperlinks is activated by the user (140), the browser's default action (typically, to retrieve and display material from the hyperlink's target) is extended by transmitting an exit notification (150) before the browser navigates to the hyperlink destination (160).

At the other end of the exit-notification transmission (150), the web server that originally provided the executable program (or, sometimes, a different sewer) receives the notification (170) and records the information in a database (180) for later analysis.

Listing 1 shows a simple code fragment that can be added to documents at a server to cause the browser to retrieve the executable program:

10<script src=“js/jquery-1.4.2.min.js” type=“text/javascript”></script>

### Listing 1

This code fragment can often be added on a site-wide basis by editing a single, commonly-included header file, or by inserting it as a customization to the framework code of a Content Management System (“CMS”). Alternatively, it can be added on an ad-hoc basis to particular files for which exit tracking is desired.

Listing 2 shows an example JavaScript method that can be attached to a hyperlink in the DOM to perform exit tracking:

| | |
|---|---|
| 10 | <script type=“text/javascript”> |
| 20 | function saRthree(linkObj) { |
| 30 | var linkHref = linkObj.attr(‘href’); |
| 40 | var linkTarget = linkObj.attr(‘target’); |
| 50 | if (typeof $AOC != ‘undefined’ && typeof $SAT != |
| | ‘undefined’) { |
| 60 | $AOC.addHiddenImageToDocument( |
| 70 | ADMITONE.pageHitUrl + “?id=” + |
| 80 | $AOC.getTransactionID( $AOC.targetWindow( ) ) + |
| 90 | “&sn=” + |
| | $AOC.getSessionID($AOC.targetWindow( )) + |
| 100 | “&msg=” + “Exiting anchor tag click recorded” + |
| 110 | ((typeof scoutTransactionTypeInt != ‘undefined’) |
| 120 | ? “&type=” + scoutTransactionTypeInt : “”) + |
| 130 | “&url=” + encodeURIComponent(linkHref) + |
| 140 | “&rf=” + encodeURIComponent(document.URL) + |
| 150 | (($SAT.getUser( ) !== ‘’) ? “&u=” + |
| | $SAT.getUser( ) : “”) ); |
| 160 | } |
| 170 | window.open(linkHref, linkTarget); |
| 180 | } |
| 190 | </script> |

### Listing 2

And finally, Listing 3 shows an example JavaScript program to iterate over hyperlinks in a DOM and attach an exit-tracking function to (some of) them:

| | |
|---|---|
| 10 | <script type=“text/javascript”> |
| 20 | $(document).ready(function( ) { |
| 30 | $(“a[href\hat{ }=‘http://www.somesite.com’], a[href$=‘.pdf’], |
| | a[href*=‘/videos/’]”) |
| 40 | .click(function( ) { |
| 50 | saRthree($(this)); |
| 60 | return false; |
| 70 | }); |
| 80 | }); |
| 90 | </script> |

### Listing 3

This example uses the jQuery library; the selector at line 30 identifies a subset of hyperlink (“anchor”) tags that should be tracked (in this example, exit URLs that start with “www.somesite.com”, that end with a “.pdf” extension, or that are present in a “videos” subdirectory).

Listing 4 shows a more-complicated jQuery routine that arranges for more detail about the exit destination to be passed to the exit tracking server than the saRthree( ) function shown above in Listing 2.

| | |
|---|---|
| 10 | <script type=“text/javascript”> |
| 20 | function saHrefRec(linkObj) { |
| 30 | var linkHref = linkObj.attr(‘href’); |
| 40 | var linkTarget = linkObj.attr(‘target’); |
| 50 | var aUrl = linkHref.replace(“//”, “”).split(“/”); |
| 60 | var aTitle = linkObj.text( ); |
| 70 | var aUrlLen = aUrl.length; |
| 80 | var yrPos = aUrlLen − 2; |
| 90 | var aDate = ‘’ + aUrl[yrPos]; |
| 100 | var yrFound = false; |
| 110 | while (yrPos > 0 && !yrFound) { |
| 120 | if (aUrl[yrPos].length == 4) { |
| 130 | yrFound = true; |
| 140 | } else { |
| 150 | −−yrPos; |
| 160 | aDate = aUrl[yrPos] + ‘-’ + aDate; |
| 170 | } |
| 180 | } |
| 190 | var aDocType = aUrl[yrPos − 1]; |
| 200 | if (yrPos == 6) { |
| 210 | var aServiceCode = aUrl[4]; |
| 220 | } else { |
| 230 | var aServiceCode = aUrl[3]; |
| 240 | } |
| 250 | $SAT.push([‘setContent’,‘docType’,aDocType]); |
| 260 | $SAT.push([‘setContent’,‘serviceCodes’,aServiceCode]); |
| 270 | $SAT.push([‘setContent’,‘title’,aTitle]); |
| 280 | $SAT.push([‘setContent’,‘postDate’,aDate]); |
| 290 | if (typeof $AOC != ‘undefined’ && typeof $SAT != |
| | ‘undefined’) { |
| 300 | $AOC.addHiddenImageToDocument( |
| 310 | ADMITONE.pageHitUrl + “?id=” + |
| 320 | $AOC.getTransactionID($AOC.targetWindow( )) + |
| 330 | “&sn=” + $AOC.getSessionID($AOC.targetWindow( )) + |
| 340 | “&msg=” + “Anchor tag click recorded” + |
| 350 | ((typeof scoutTransactionTypeInt != ‘undefined’) |
| 360 | ? “&type=” + scoutTransactionTypeInt : “”) + |
| 370 | “&url=” + encodeURIComponent(linkHref) + |
| 380 | “&rf=” + encodeURIComponent(document.URL) + |
| 390 | (($SAT.getUser( ) !== ‘’) ? “&u=” + $SAT.getUser( ) : |
| | “”) + |
| 400 | (($SAT.getContent( ) !== ‘’) ? “&ct=” + |
| 410 | encodeURIComponent($SAT.getContent( )) : “”) ); |
| 420 | } |
| 430 | window.open(linkHref, linkTarget); |
| 440 | } |
| 450 | </script> |

### Listing 4

In some embodiments, the anchor-tag processing function (e.g., Listing 3) may be designed to attach different tracking functions to different subsets of hyperlinks in the DOM. For example, tags with a particular “id” or “class” specification may be outfitted with different functions. Different target (“href”) destinations may call for different functions. These different functions may report different information to the exit tracking server, or may report tracking information to different exit tracking servers (e.g., there may be separate tracking servers for video exits, PDF exits, and e-commerce site exits).

The embodiments described to this point have been suited for deployment at a single site (or within a single domain). However, by adding a few extra elements, exit tracking can be provided on a “service bureau” basis. I.e., a web analytics firm can provide exit tracking (along with other visitor analyses) for a plurality of unrelated customers who operate websites at different, unrelated domains. Each customer can receive exit-tracking information, even if the exit destination site operators are not also clients of the service bureau.

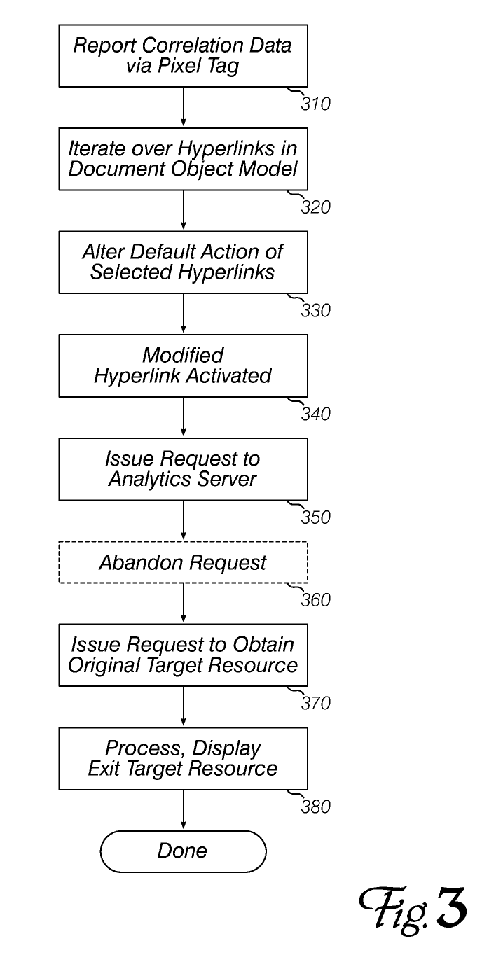

To accomplish this, the website of a customer of the web-analytics service bureau transmits an executable program to its site visitors, just as if the customer was operating its own stand-alone embodiment. However, this executable program performs additional operations, as outlined in FIG. 3.

Early in the creation or processing of the Document Object Model for the instrumented web page, executable code implementing an embodiment of the invention reports correlation data to the analytics server (310). This can be accomplished by adding a small, transparent image (a “pixel tag”) to the DOM, to cause the browser to retrieve the image from the analytics server. The data retrieved is relatively unimportant; this request from the browser is principally useful because it causes the browser to report information about the browser and the page (at the analytics-customer's web site) that is being displayed. The information often comprises a unique token or tracking string to help the analytics server distinguish between different browsers that happen to be viewing the same resource at the web server.

Next, as in the self-hosted embodiments, the executable program iterates over hyperlinks in the DOM (320) and supplements or replaces the default action in some or all of the links (330). When one of the modified hyperlinks is activated (340), instead of navigating directly to the target URL, the browser executes additional code to issue another request to the analytics server (350). The request lists the current page as the referrer and the hyperlink's target URL as the source page. Additional details (e.g., the unique token or tracking string) may also be included in the request. The resource retrieved by this request is, again, relatively unimportant, but the fact that the request was issued allows the analytics server to record useful information such as the amount of time the user spent viewing the page and the exit destination URL. The executable code that handles the hyperlink activation may even abandon the HTTP request after issuing it (360).

Finally, the executable code directs the browser to retrieve the off-site target resource (370), and the browser's normal logic takes over to process and display the resource (380). In a practical implementation, the target-URL-processing code of an embodiment may include tests for conditions that could prevent the exit link from being opened as expected by the original anchor tag.

It is appreciated that instrumented or augmented hyperlinks need not refer to external or cross-domain resources; an embodiment may be applied to any hyperlinks found in the DOM.

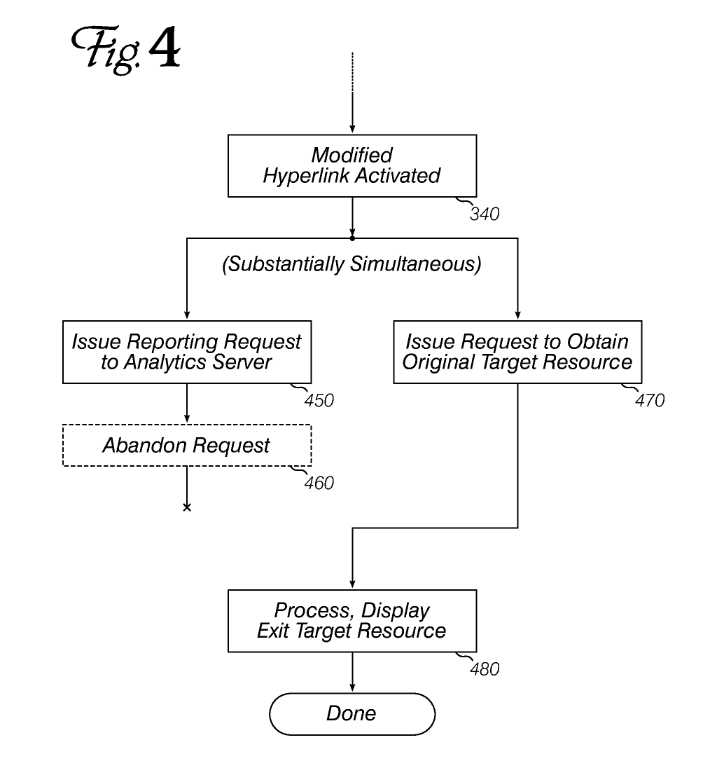

FIG. 4 highlights an important feature of a preferred embodiment of the invention. Starting with the activation of a modified hyperlink (340), as discussed with respect to FIG. 3, the embodiment issues the “reporting” request to the analytics server (450) in parallel with the request to obtain the resource that was the original target of the modified hyperlink (470). Again, the response to the reporting request is unimportant and the request may be abandoned after issuance (460). An embodiment thus uses the HTTP request mechanism “backwards,” to communicate information to the analytics server, rather than the conventional direction (which is to cause the server to send a requested resource to the client).³ Thus, the reporting request may also be seen as a “dummy” request, which accomplishes the purposes of an embodiment without regard to the contents of a response elicited by the request, or even whether a response is received at all. Tracking information can be reported as part of the URL of the dummy request, as a QUERY_STRING suffix to the URL, as a Hypertext Transfer Protocol (“HTTP”) header, as POST data, or in another portion of the request. ³It is appreciated that HTTP defines a “PUT” request (as well as the more-common “GET” request). A PUT request is specifically designed to perform client-to-server data transfer. An embodiment can use the incidental client-to-server transfer of a GET request, or a PUT request (or, indeed, any of several other HTTP requests), to accomplish the reporting described here.

Since the requests (450, 470) are issued in parallel, the user's experience is not delayed by the processing time of the analytics server, as would be the case with a conventional exit-tracking method involving a reporting-and-redirect process. Instead, the client's browser quickly proceeds to obtain, process and display the resource associated with the instrumented hyperlink's original target location.

Software engineers of ordinary skill will recognize that “parallel” execution, in the narrowest sense of “simultaneous performance of two different instruction sequences,” is often impossible in light of hardware and software limitations. However, most contemporary computers, operating systems, and software execution environments available within a web browser can simulate parallel or simultaneous execution by means of time sharing, threading, asynchronous callback notifications, and similar constructs. An embodiment of the invention may leverage such facilities to accomplish program behavior that appears (at a macro level) to be concurrent, simultaneous or otherwise parallel.

An embodiment of the invention may be a machine-readable medium having stored thereon data and instructions to cause a programmable processor to perform operations as described above. In other embodiments, the operations might be performed by specific hardware components that contain hardwired logic. Those operations might alternatively be performed by any combination of programmed computer components and custom hardware components.

Instructions for a programmable processor may be stored in a form that is directly executable by the processor (“object” or “executable” form), or the instructions may be stored in a human-readable text form called “source code” that can be automatically processed by a development tool commonly known as a “compiler” to produce executable code. Instructions may also be specified as a difference or “delta” from a predetermined version of a basic source code. The delta (also called a “patch”) can be used to prepare instructions to implement an embodiment of the invention, starting with a commonly-available source code package that does not contain an embodiment.

In some embodiments, the instructions for a programmable processor may be treated as data and used to modulate a carrier signal, which can subsequently be sent to a remote receiver, where the signal is demodulated to recover the instructions, and the instructions are executed to implement the methods of an embodiment at the remote receiver. In the vernacular, such modulation and transmission are known as “serving” the instructions, while receiving and demodulating are often called “downloading.” In other words, one embodiment “serves” (i.e., encodes and sends) the instructions of an embodiment to a client, often over a distributed data network like the Internet. The instructions thus transmitted can be saved on a hard disk or other data storage device at the receiver to create another embodiment of the invention, meeting the description of a machine-readable medium storing data and instructions to perform some of the operations discussed above. Compiling (if necessary) and executing such an embodiment at the receiver may result in the receiver performing operations according to a third embodiment.

In the preceding description, numerous details were set forth. It will be apparent, however, to one skilled in the art, that the present invention may be practiced without some of these specific details. In some instances, well-known structures and devices are shown in block diagram form, rather than in detail, in order to avoid obscuring the present invention.

Some portions of the detailed descriptions may have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the preceding discussion, it is appreciated that throughout the description, discussions utilizing terms such as “processing” or “computing” or “calculating” or “determining” or “displaying” or the like, refer to the action and processes of a computer system or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, including without limitation any type of disk including floppy disks, optical disks, compact disc read-only memory (“CD-ROM”), and magnetic-optical disks, read-only memories (ROMs), random access memories (RAMs), erasable, programmable read-only memories (“EPROMs”), electrically-erasable read-only memories (“EEPROMs”), magnetic or optical cards, or any type of media suitable for storing computer instructions.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will be recited in the claims below. In addition, the present invention is not described with reference to any particular programming language. It will be appreciated that a variety of programming languages may be used to implement the teachings of the invention as described herein.

The applications of the present invention have been described largely by reference to specific examples and in terms of particular allocations of functionality to certain hardware and/or software components. However, those of skill in the art will recognize that website visitor exit tracking can also be produced by software and hardware that distribute the functions of embodiments of this invention differently than herein described. Such variations and implementations are understood to be captured according to the following claims.

I claim:

1. A method for collecting information about a user visiting a website using a browser comprising:
transmitting a program to a browser at a client computer, the program containing instructions to cause the browser to perform operations including:
a) identifying a plurality of hyperlink objects in a document object model (“DOM”), each hyperlink object having a target location and a default action if the hyperlink object is activated; and
b) altering the default action of a hyperlink object of the plurality of hyperlink objects to cause the hyperlink object to transmit a message if the hyperlink object is activated;
and, receiving a message from the client computer, said message containing the target location of one of the identified hyperlink objects in the DOM, and said message transmitted by the altered default action of the hyperlink object.

2. The method of claim 1 wherein the program contains additional instructions to cause the browser to perform further operations including:
c) adding an element to the DOM to cause the browser to report tracking information to a server before any altered hyperlink is activated.

3. The method of claim 2 wherein the element is an image element.

4. The method of claim 1 wherein the message from the client computer is a dummy request for a resource, said dummy request issued in parallel with a conventional request to obtain a resource identified by the target location of the hyperlink object.

5. The method of claim 4 wherein the dummy request is a Hypertext Transfer Protocol (“HTTP”) “GET” request whose parameters convey information about the target location.

6. The method of claim 1 wherein the program is a JavaScript program.

7. The method of claim 6 wherein the JavaScript program employs a jQuery library of functions.

8. A computer-readable medium containing executable instructions to cause a browser to perform operations comprising:
identifying anchor tags in a Document Object Model (“DOM”) constructed by the browser, each anchor tag having a target location; and
altering a default action taken by the browser in response to an activation of an identified anchor tag, so that
if the anchor tag is activated, the browser:
a) reports a portion of the target location of the anchor tag to a reporting server; and
b) retrieves a resource from a target server at the target location, wherein
a domain of the reporting server is different from a domain of the target server.

9. The computer-readable medium of claim 8 wherein the portion of the target location is the domain of the target server.

10. The computer-readable medium of claim 8 wherein the portion of the target location is all of the target location.

11. The computer-readable medium of claim 8 wherein the altering operation does not affect a text representation of a source document from which the browser constructed the DOM.

12. The computer-readable medium of claim 8 wherein the reporting and retrieving actions proceed substantially simultaneously.

13. The computer-readable medium of claim 8 wherein identifying comprises selecting anchor tags having at least one of:
a predetermined target domain;
a predetermined anchor class setting;
a predetermined anchor identification (“ID”) setting;
a predetermined partial URL path; or
a predetermined target resource type.

14. The computer-readable medium of claim 8 wherein identifying anchor tags comprises identifying a plurality of anchor tags, and wherein
a default action of a first anchor tag of the plurality of anchor tags is altered so that the browser reports a first selection of information to the reporting server, and
a default action of a second anchor tag of the plurality of anchor tags is altered so that the browser reports a second, different selection of information to the reporting server.

15. An Internet content-delivery system comprising:
a content web server to receive a request from a browser for a document and to transmit the document to the browser;
a program web server to receive a request from the browser for an exit-tracking executable program and to transmit the exit-tracking executable program to the browser;
a database; and
a tracking server to receive a dummy request from the browser and to store information from the dummy request in the database.

16. The Internet content-delivery system of claim 15 wherein the content web server is to modify the document before transmitting the document to the browser, said modified document to cause the browser to transmit a request to the program web server to retrieve the exit-tracking executable program.

17. The Internet content-delivery system of claim 15 wherein the exit-tracking executable program is to cause the browser to alter a hyperlink in a Document Object Model (“DOM”) constructed by the browser based on the document, without altering a text representation of the document, and wherein
the altered hyperlink is to cause the browser to transmit the dummy request to the tracking server.

18. The Internet content-delivery system of claim 15 wherein the content web server and the program web server are the same web server.

19. The Internet content-delivery system of claim 15, further comprising:
a correlation web server to receive a tag request from the browser for an image tag, to store information from the tag request in the database, and to transmit a response to the browser.

20. The Internet content-delivery system of claim 19 wherein the tracking server and the correlation web server are in the same domain, and the content web server is in a domain different from a domain of the tracking server.

21. The Internet content-delivery system of claim 15, further comprising:
an analysis server to produce a report based on information in the database, said report to show information about the browser and information from the dummy request.
